(19) United States
(12) Patent Application Publication
(10) Pub. No.: US 2007/0205025 A1
(43) Pub. Date: Sep. 6, 2007

(54) Luggage with an integrated scale for measuring its weight

(76) Inventor: Ashraf Taha, Watchung, NJ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/368,775

(22) Filed: Mar. 6, 2006

(51) Int. Cl. G01G 23/00; G01G 19/00

(52) U.S. Cl. 177/245

(57) ABSTRACT

A combined luggage and scale comprising a luggage platform for holding a plurality of items, an attachable scale for measuring the weigh of the items and a readout for reading the weight.

### FIELD OF THE INVENTION

The present invention is directed to the field of luggage weight measuring devices. In particular, the present invention comprises luggage with an integrated scale for measuring its weight.

### BACKGROUND OF THE INVENTION

One of the most inconvenient aspects of modern life is the need to pack suitcases and the like. Today, airlines typically charge extra for weight overages. There has not been an easy system for permitting travelers to pre-weigh luggage. In the event that luggage is overweight, passengers are assessed steep penalties. There have been a number of patents issued in the area of luggage weight measuring devices. None are integral to the luggage.

U.S. Patent Application No. 20020113715 discloses a system which is used for simultaneously verifying the conformity of carry-on luggage to maximum permissible size and weight values, such as the ones imposed by airline companies. The system comprises a sizing template having a receiving area and an opened side allowing insertion and removal of the carry-on luggage from the receiving area. The receiving area of the sizing template has dimensions delimiting the maximum permissible size values to which the carry-on luggage has to conform. The system further comprises a weight sensor configured and disposed with reference to the sizing template to measure the weight value of the carry-on luggage once it is set in the receiving area thereof. A display unit, responsive of the weight value of the carry-on luggage, allows it to indicate whether the carry-on luggage is conform with respect to the maximum whether the carry-on luggage is conform with respect to the maximum permissible weight value or not. This system is particularly useful in airports but could be used with other transportation systems as well.

U.S. Patent Application 20040130047 discloses a luggage identifier for air and rail travelers uniquely identifies a luggage piece on a airport carousel or train station conveyer belt. A battery powered remote radio wave transmitter carried by the passenger sends a radio wave to a battery powered receiving and activating mechanism associated with the luggage piece. The transmitted signal triggers a latch release mechanism connected to a flexible flagpole that is held under spring tension in the collapsed state. Upon being triggered, the latch release mechanism releases the flagpole, which is driven to an extended state under spring power. Identifiers carried by the flagpole are thereby moved into a conspicuously visible position, which facilitates identification of the luggage piece. The identifiers can comprise LED lights mounted on the flexible flagpole, a colored puffball, a name flag, and a sound generation mechanism. Additional identifiers can comprise a strip of light bulbs or LED lights disposed within cording of the luggage, a sewn-in housing light panel, and a privacy panel removably affixed to a sewn-in panel by hook and loop fasteners or the like. Flagpole extension proceeds to the extent permitted by the space available amongst contiguous luggage pieces. The component parts of the flagpole have sufficient flexibility to tolerate impact with adjacent objects, such as nearby baggage pieces or the edge of an airport carousel. Unique colors exhibited by the flag, and/or name identifiers on the pole operate to provide highly visible indicia that identify luggage or a backpack even in dimly lit areas.

U.S. Patent Application 20040075554 discloses a system for locating and identifying a system for locating and identifying luggage comprising a signaling unit and an identifying unit. The signaling unit includes an electromagnetic signal transmitter electronically coupled to a switch. Actuation of the switch causes the signal transmitter to generate an electromagnetic signal. The identifying unit is affixed to the luggage and includes an electromagnetic signal receiver to receive the electromagnetic signal. The identifying unit further includes a sound producing element electronically coupled to the signal receiver such that the sound producing element emits an identifying sound following receipt of the electromagnetic signal by the signal receiver. The identifying unit may also include an optional light source that emits light following receipt of the electromagnetic signal to further assist in location and identification of the luggage.

While there are a number of prior art systems for measuring luggage weight, none of the prior art disclose a system for pre-weighing luggage using a integral or attachable scale, attached or attachable to the luggage.

It is therefore on object of the invention to disclose a scale for use in a piece of luggage.

It is a further object of the invention to provide a system in which an electronic or mechanical scale can be used to measure the weight of items inside a suitcase or luggage.

It is a further object of the invention to provide a system in which the contents of a suitcase or luggage can be weighed.

These and other objects of the present invention will become apparent from the detailed description which follows.

### SUMMARY OF THE INVENTION

In accordance with the invention, a combined luggage and scale comprising of a luggage platform for holding a plurality of items, an integral scale for measuring the weight of the items and a readout for displaying the weight.

In a further embodiment, the invention is a combined luggage and scale comprising of a luggage platform for holding a plurality of items to be packed, an integral scale affixed to the base of the platform for measuring the weight of the luggage and items and a digital readout for displaying the weight.

In still a further embodiment, the invention is a combined luggage and scale comprising of a luggage platform for holding a plurality of items, an attachable scale for measuring the weigh of the items and a readout for reading the weight.

### DESCRIPTION OF THE FIGURES

FIG. 1 is a perspective view of the weight system of the present invention.

FIG. 2 is a perspective view of the present invention.

FIGS. 3 to 5 illustrate the scale of the first present invention.

FIGS. 6 to 10 illustrate an alternative embodiment.

FIG. 11 is a functional block diagram of the first embodiment.

FIG. 12 is a second alternative embodiment of the invention.

FIG. 13 is a digital readout.

FIG. 14 is a strain gauge scale.

### BRIEF DESCRIPTION OF THE PREFERRED EMBODIMENT

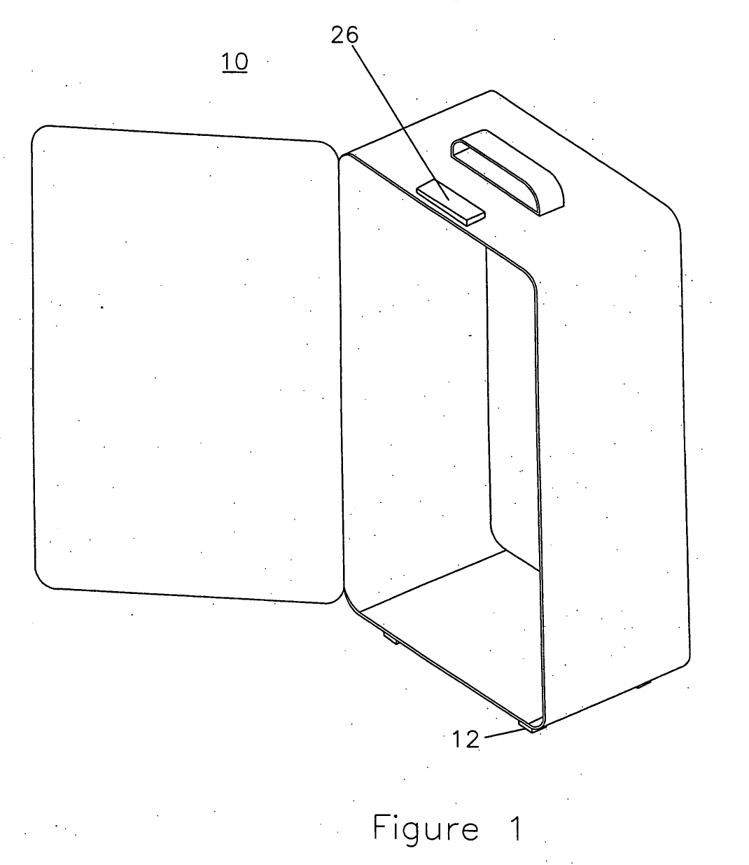

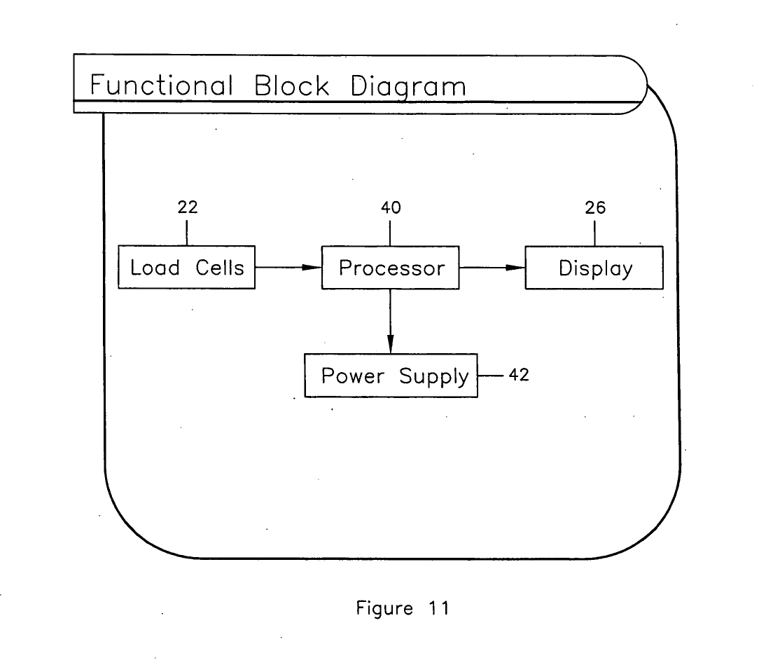

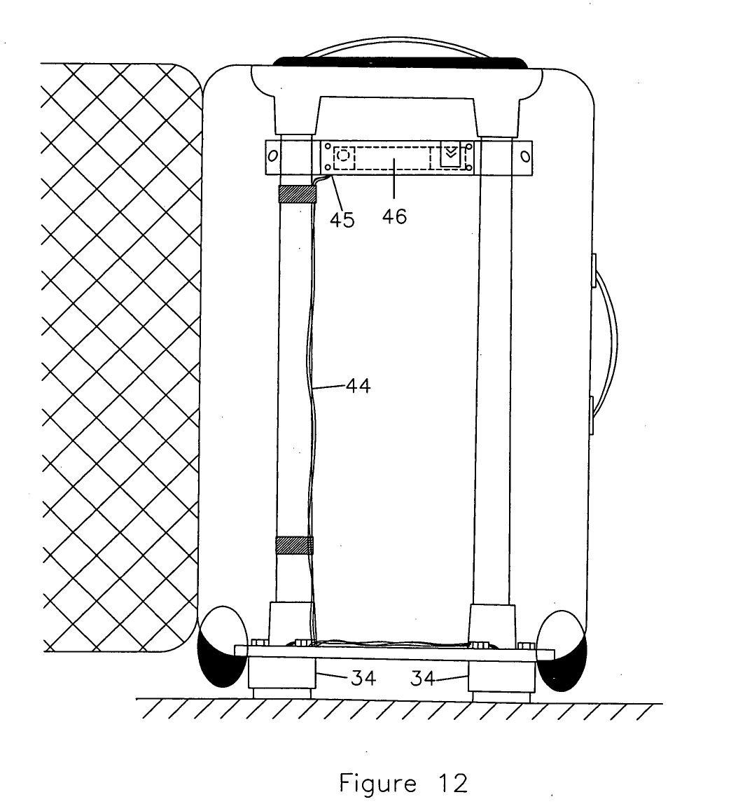

The present invention is described with reference to the enclosed figures. The invention is specifically directed to a system for weighing the contents of a suitcase or bag. In a first embodiment, shown in FIGS. 1 to 5, the scale is integral with the suitcase, bag or luggage. In the first embodiment, the invention comprises a bag 10 with an electronic scale 12. The luggage has a base 14 and a plurality of wheeled dollies 15. The base 16 supports an electronic scale 18 situated in the base 16. The base 16 thus includes a foot 20, load cell 22 and load plate 24. The load plate 24, in a first embodiment comprises the scale 18. The scale 18 measures the weight which will appear on a digital readout 26 attached to a side of the bag. Referring to FIG. 11, the embodiment of FIGS. 1 to 5, include a processor 40 and power supply 42.

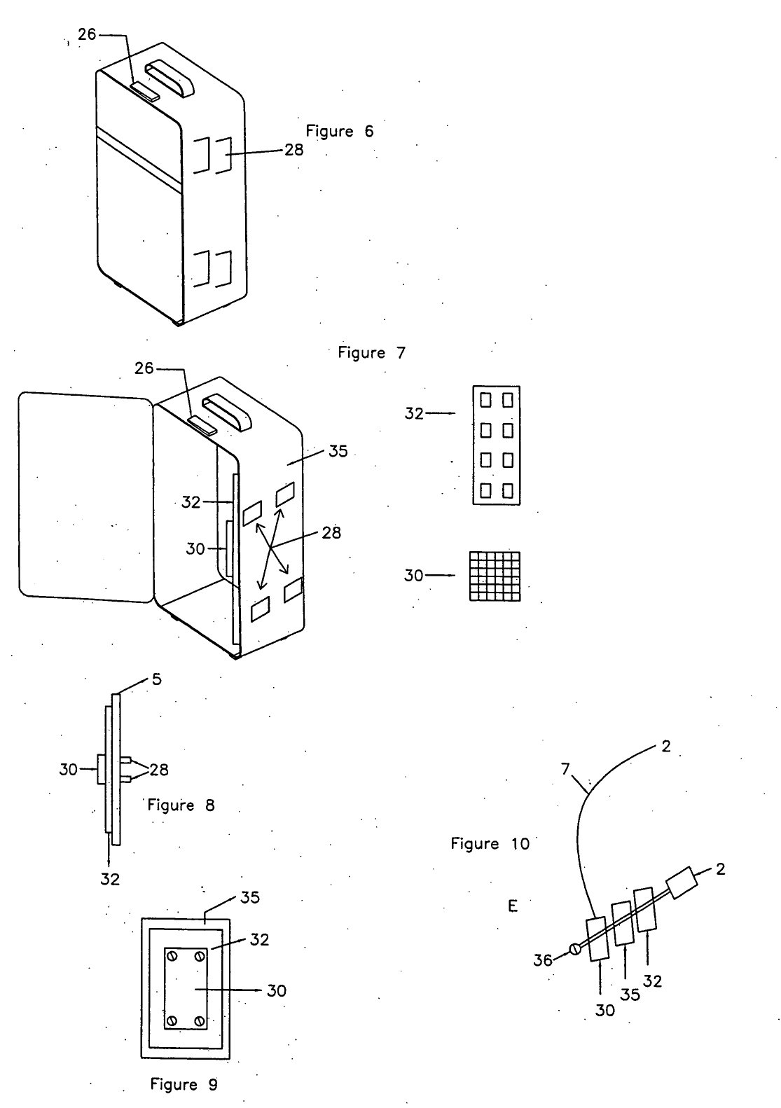

In an alternative embodiment, shown in FIGS. 6 to 11, the scale system is located on the side of the bag, luggage and may be selectively attached and removed. In use, the side of the bag is turned downward where the scale attached to insertable or connectable spokes 28 and used to measure the weight of the bag. The spokes 28 support a digital scale 30 and digital sensors 32. The scale 30 may be connected electronically to a digital readout. The scale 30, spokes 28, and sensors 32 are attached via a screw.

Alternatively, in this embodiment, the scale may be mechanical. The mechanical scale is attached to a spring which provides an analog readout. The scale can be selectively placed on the rear of luggage (opposite of front when standing up) or side of luggage (opposite handle of most luggage).

The design is thus a universal design that will enable placement of the scale into any existing piece of without the need to redesigning luggage line. It is to be appreciated that the scale can be adjusted to factor in the weight of the bag or luggage.

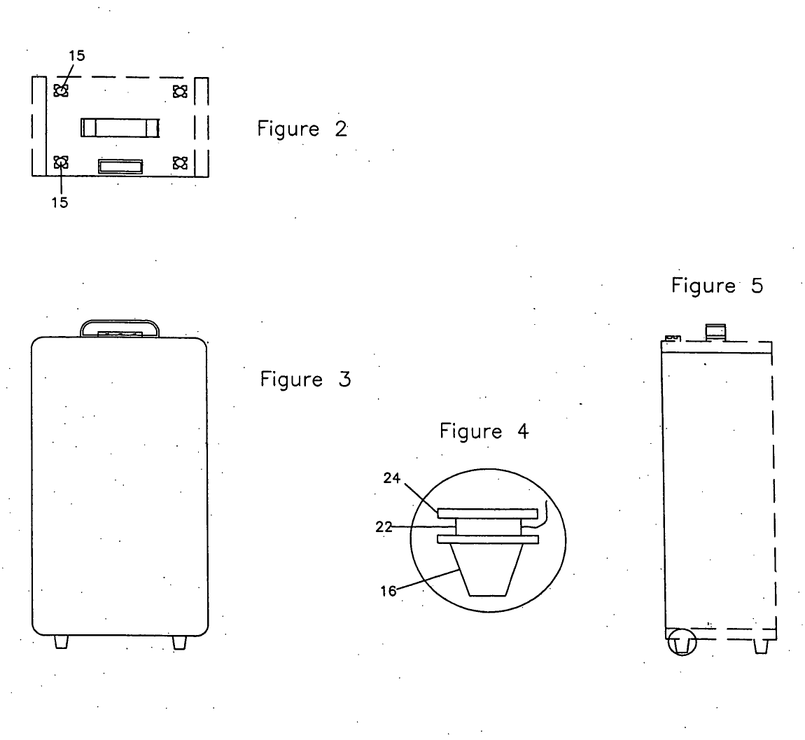

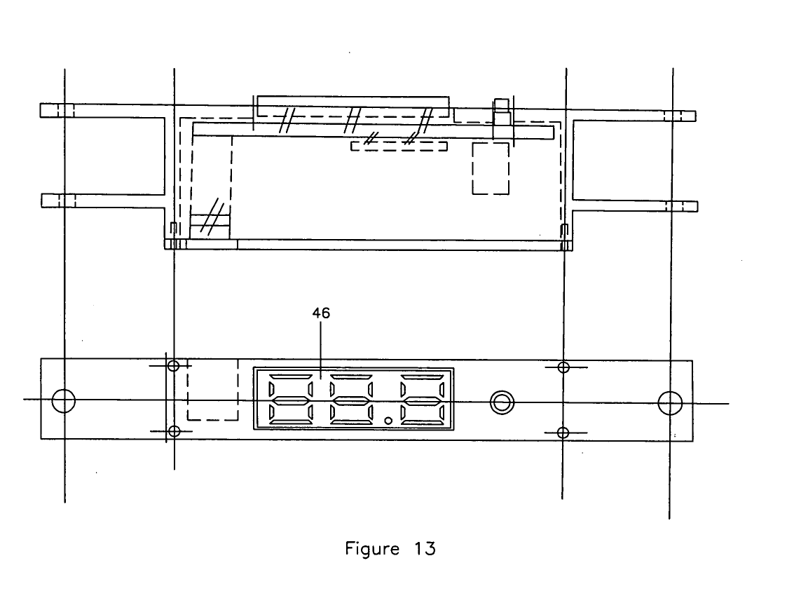

Referring to FIGS. 2 to 14, on alternative embodiment of the invention is shown. In FIG. 12, the cable comprises two strain gauges 34 which hold the bag in an elevated position. The gauges are connected by a wire 44 to a processor 45.

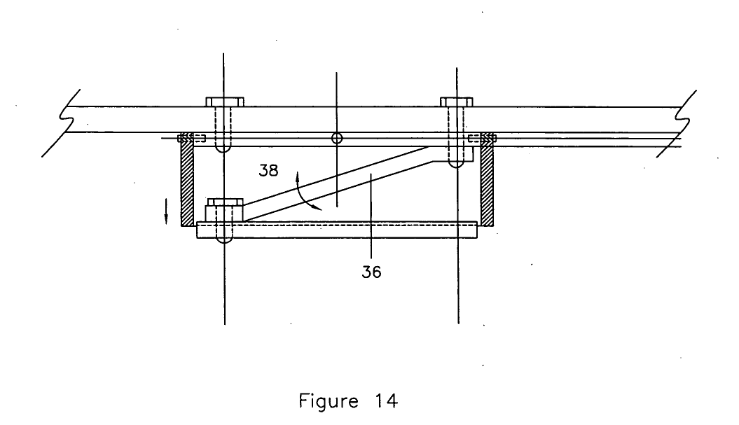

As shown in FIG. 14, the strain gauge comprises a lever 36. As weight is place in the bag, the gauge bends 38 and a sensor sends an electrical signal related to the downward weight of the bag. This is transmitted to the processor 45 then which generates a digital readout of the weight which appears on readout 46.

The present invention has been described with reference to the enclosed figures. The true nature and scope of the invention is to be determined with reference to the claims appended hereto.

1. A combined luggage and scale comprising:
a luggage platform for holding a plurality of items;
an integral scale for measuring the weigh of the items; and
a readout for displaying the weight.

2. The combined luggage and scale of claim 1 wherein the scale is an electronic scale.

3. The combined luggage and scale of claim 1 wherein the scale is a mechanical scale.

4. The combined luggage and scale of claim 1 wherein the scale can is affixed to the base of the luggage.

5. The combined luggage and scale of claim 1 wherein the scale is selectively attached to the side of the bag.

6. A combined luggage holder and scale comprising:
a luggage platform for holding a plurality of luggage and other items;
an integral strain gauge scale affixed to the base of the platform for measuring the weight of the luggage and items; and
a digital readout for displaying the weight.

7. A combined luggage and scale comprising:
a luggage platform for holding a plurality of items;
an attachable scale for measuring the weigh of the items; and
a readout for reading the weight.

8. The combined luggage holder and scale of claim 6 wherein the scale is an electronic scale.

9. The combined luggage holder and scale of claim 6 wherein the scale is an mechanical scale.
